(19) United States
(12) Patent Application Publication
(10) Pub. No.: US 2021/0174163 A1
(43) Pub. Date: Jun. 10, 2021

(54) EDGE INFERENCE FOR ARTIFICAL INTELLIGENCE (AI) MODELS

(71) Applicant: International Business Machines Corporation, Armonk, NY (US)

(72) Inventors: Dinesh C Verma, New Castle, NY (US); Seraphin Bernard Calo, Cortlandt Manor, NY (US)

(21) Appl. No.: 16/708,751

(22) Filed: Dec. 10, 2019

(51) Int. Cl. G06N 3/04; G06N 3/08; G06F 16/953; G06F 9/50; G06K 9/62

(52) U.S. Cl. CPC G06N 3/0418; G06N 3/08; G06K 9/6256; G06F 9/505; G06F 9/5083; G06F 16/953

(57) ABSTRACT

In some examples, a client accesses an AI-enabled web solution through an edge device. The edge device has one or more locally cached faster first AI models, and is also connected to a remotely stored slower, but more accurate and complex, second AI model. The edge device may execute an inference operation using one of the simpler models, but its result may deviate from that of the complex cloud based model. In embodiments, to improve the accuracy and still obtain the benefit of faster response time from a locally cached model, an intelligent cache decision maker is provided. The cache decision maker includes a third AI model, trained to determine, on a per request basis, whether one of the simpler models at the edge may be used, or whether it is necessary to use the more complex cloud based model to respond to the client request.

### BACKGROUND

The present invention relates to the use of multiple AI models, and more specifically to selecting, at an edge device, between a locally stored AI model and a cloud based AI model in response to a client request.

For any AI enabled solution, many different types of AI models can be used. These models may vary in efficiency, complexity, and speed. Conventional practice regarding the use of multiple models is to either select one of them using predefined criteria or validation procedures, or, for example, to combine the models in an ensemble. However, in contexts such as choosing either cloud based AI models or locally cached versions of the same models at an edge device, these approaches are inadequate, as the outcome or result of a locally cached model may not always match the outcome or result of the cloud based service. This outcome discrepancy may be due, for example, to the fact that techniques such as transfer learning, or model compression, may be used to create a simpler model to be cached on an edge device. When implemented, the local, more simplified, model may deviate from the behavior of the cloud based model.

It is useful to provide solutions to these problems of multiple AI models and their use, especially where an AI model is provided both in the cloud, and also cached at an edge device.

### SUMMARY

According to one embodiment of the present disclosure, a method is provided. The method includes receiving a client request at a device, and determining if a response to the request from a first locally stored AI model is predicted to be the same as a response to the request from a second either locally or remotely stored AI model, wherein the second AI model is more complex than the first AI model. The method further includes, in response to a determination that the responses are predicted be the same, selecting the first model, and providing a response to the client from the first model.

According to a second embodiment of the present disclosure, a system is provided. The system includes a client interface configured to receive a client request and provide a response, a memory, configured to store a first AI model, and a network interface, configured to communicate with a second AI model stored on a cloud server, the second AI model more complex than the first. The system further includes a cache decision maker, coupled to the client interface, configured to analyze the client request, and, based at least in part on the analysis, select either the first AI model or the second AI model to respond to the request.

According to a third embodiment of the present disclosure, a computer-readable storage medium is provided. The computer-readable storage medium has computer-readable program code embodied therewith, the computer-readable program code executable by one or more computer processors to perform an operation. The operation includes to receive a request from a client, and determine if a first response to the request from a first locally stored AI model is predicted to be the same as a second response to the request from a second either locally or remotely stored AI model, the second AI model more complex than the first. The operation further includes, in response to a determination that the responses are predicted to be the same, to select the first model, and provide a response to the client from the first model.

### BRIEF DESCRIPTION OF THE SEVERAL VIEWS OF THE DRAWINGS

FIG. 1 illustrates a schematic drawing of an example system, according to one embodiment disclosed herein.

FIG. 2 is a block diagram illustrating a system node configured to provide cognitive multi-task orchestration of dialogues, according to one embodiment disclosed herein.

FIG. 3 illustrates an example edge device with a locally saved simple AI model, connected to a complex AI model stored in the cloud.

FIG. 4 illustrates a first example system for inference at an edge device, using a single locally cached simple model, according to one embodiment disclosed herein.

FIG. 5 illustrates a second example system for inference at an edge device, using multiple locally cached simple models, according to one embodiment disclosed herein.

FIG. 6 depicts process flow of an example AI model selection method, according to one embodiment disclosed herein.

FIG. 7 depicts process flow of an alternate example AI model selection method, according to one embodiment disclosed herein.

### DETAILED DESCRIPTION

Embodiments and examples described herein relate to selection of an appropriate AI model, out of two or more possible models, to respond to a client request. In some examples, the client request is received at an edge device, the edge device having one or more locally saved first AI models, the edge device further being able to access a remotely stored second AI model, such as, for example, one provided in the cloud. In such examples the first AI models are relatively simple in comparison with the second AI model, but have the advantage of being faster, whereas the second AI model is more complex than the first AI models, and thus more accurate, but has the disadvantage of being slower, due to one or more of longer latency or longer processing times. In alternate embodiments, both the first and the second AI models are stored on the same device, which functions, for example, as an AI enabled load balancer.

In one example, a client accesses an AI-enabled web solution through an edge device. The edge device has a locally stored simple AI model which is fast but may not be as accurate as a complex AI model stored at a cloud site which the edge device may access over a data communications network. The edge device may execute an inference operation using the simpler model, but its result may deviate from that of the complex model. It is desired that the locally cached model provide the same answer as the original server would, in response to the client request. In this example scenario, it is usually difficult to determine if the response from the cached model would match that from the cloud service, unless the cloud service is also queried.

For example, an edge device may be used to receive images and make decisions based on the image, using various AI models trained to detect a problem or one or more defects. For example, in an agricultural context, a potato producer may have freshly picked potatoes run along a conveyor belt, above which one or more high resolution cameras are provided. Images from the cameras are fed to an edge device that processes the images using one or more AI models, and determines if any of the potatoes, for example, are low grade, and need to be rejected from the lot. For example, they may look deformed, show signs of rot, or have excess greening. Exposure of potato tubers to light either in the field or in storage will induce the formation of a green pigmentation on the surface of the potato. This is called “greening” and indicates the formation of chlorophyll. The green indicates an increase in the presence of glycoalkaloids, especially, in potato, the substance “solanine.” When the potato greens, solanine increases to potentially dangerous levels, and it is increased solanine levels that are responsible for the bitter taste in potatoes after being cooked. Under US standards, a greening of 5% of a given lot of tubers is considered to be damaging and the lot will be downgraded. Therefore, green potatoes are graded out before reaching the retail market. An AI model, running on an edge device adjacent to the cameras, is used to detect excessive greening, and identify which potatoes need to be removed from the lot. The speed of decision making of the edge device directly affects the speed at which the conveyor belt can be run, and thus is directly connected to throughput.

Alternatively, an edge device may be used in a similar setup to check parts after manufacture. Based on various acquired images of the parts, AI models running on an edge device provided in the manufacturing plant are used to determine if there are any defects in the parts, and, if found, the parts are scrapped and removed from the plant's output.

Or, in another example, a drone may be used to periodically inspect bridges for cracks. In recent years, bridge inspection based on unmanned aerial vehicles (UAV) with vision sensors has received considerable attention due to its safety and reliability. A UAV equipped with a camera is used to store digital images taken during crack detection through scanning the surface of the bridge. The acquired images of the bridge are processed using deep learning-based crack detection methods. In such methods, features are extracted from the crack images by a convolutional neural network. The results of crack detection using deep learning overcome the limitations of conventional image processing techniques such as blob and edge detection. In one example method, initially a point cloud-based background model of the bridge is generated in a preliminary flight, and then inspection images from a high resolution camera mounted on a UAV are captured and stored to scan structural elements. Finally, deep learning processing is used for both image classification and localization, and crack size estimation to quantify the cracks. The UAV has a processor on board, and is thus the edge device in this scenario. Or for example, the UAV, once docked, downloads the images it has acquired to a local computer, on which is stored a simple AI model to perform the crack detection.

In each of the above-described examples, AI models may operate on large image files, for which considerable bandwidth is needed if they were to be sent to a cloud based AI model for processing. However, due to hardware, memory and processing limitations, the versions of such AI models that are stored on an edge device tend to be simpler than versions of the same AI model stored in the cloud, on one or more high performance servers. To the extent an AI model cached on a local device can do the requisite processing, and obtain the same results, as a more complex cloud based AI model, it is desired that the locally cached AI model be used.

Thus, in embodiments, in order to improve the accuracy to responses to client requests and still obtain the benefit of the faster response time from the cached model, an intelligent cache decision maker is provided. In embodiments, the cache decision maker decides, on a per request basis, whether it is better to use the simpler model at the edge, or to use the complex model from the cloud.

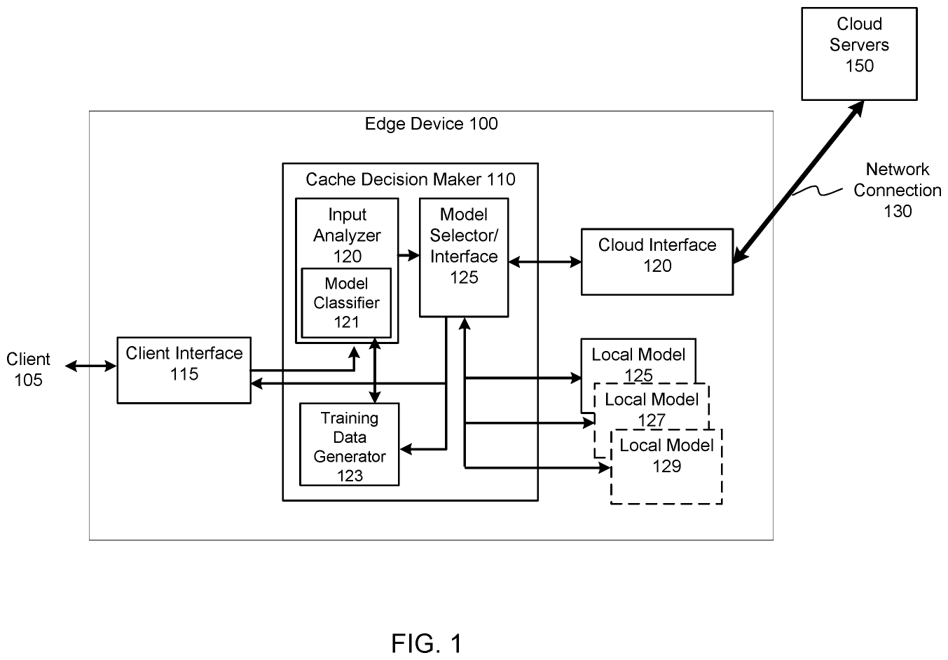

FIG. 1 illustrates a schematic drawing of an example system, according to one embodiment disclosed herein. With reference to FIG. 1 there is shown a client 105 and an edge device 100. Client 105 interacts with a client interface 115 on edge device 100. The client may be, for example, a human user, or, for example, in what is a more common scenario, a computer program that accesses an AI-enhanced web solution through edge device 100.

Edge device 100 includes a cache decision maker 110, a memory 111 and a cloud interface 130. Memory 111 stores, on the edge device, one or more local models, shown as local model 126, and optionally local models 127 and 128 (thus the latter two shown in dashed lines in FIG. 1). These models, as noted above, are faster, but more simple (and thus, in some cases, less accurate) versions of AI models designed or trained for the same functionality. Cache decision maker 110 can access each of the local models via communications links, as shown. In some embodiments, the local AI models 126-128 are generated from the more complex cloud based versions of these AI models via at least one of transfer learning or model compression. The cloud based versions of the AI models may be stored on cloud servers 150, described below. Through cloud interface 130 and network connection 131, for example a data network, edge device 100 communicates and exchanges data with cloud servers 150, over network connection 131. It is at cloud servers 150 that the more complex versions of local AI models 126-128 are stored. In embodiments, cloud servers 150 are high performance computing devices, with multiple processor cores and multiple graphic processing units. They can thus perform detailed computations when processing images, such as is needed in the various example AI model use cases described above. As noted above, a drawback of using the more complex cloud based AI models is that they are slower than their simplified counterparts, so results cannot be provided as quickly. Moreover, there is greater latency in sending large image files over network connection 130. It is thus preferred, to the extent possible, to use local models 126-128. This requires knowing when the results provided by local models 126-128 will be the same as the results provided by their more complex counterparts stored in the cloud. Knowing when this is, and when it is not, the case, is the function of cache decision maker 110, and in particular, input analyzer 120, next described.

Continuing with reference to FIG. 1, as noted, cache decision maker 110 includes input analyzer 120. Cache decision maker 110 also includes model selector 125 and training data generator 123. Input analyzer 120 is tasked with receiving the client request from client interface 115, which is its input, and analyzing the input to determine whether a cached local model may be used to respond to the client request, or whether a more complex AI model stored in the cloud is required. Input analyzer 120 performs this task using classifier model 121, which is a third AI model that is trained to determine, for a given client request, whether a simpler local model would provide results compatible with the counterpart complex model stored in the cloud. As described in detail below, classifier model 121 of input analyzer 120 is trained to recognize the types of inputs where the simple model is suitable, and those for which it is not. In embodiments, classifier model 121 is trained using data generated by training data generator 123, described more fully below. Thus, in embodiments, input analyzer 120 checks incoming client requests and decides whether to use a simple local model at the edge, which may be known as a “cache hit”, or whether to use a more complex model in the cloud, which may be known as a “cache miss.”

In embodiments, input analyzer forwards its decision to model selector 125, which both selects, and acts as an interface to, the model designated by input analyzer 120. Model selector, as shown in FIG. 1, is communicably connected to each local model in memory 111, over communications links 113, as well as to counterpart complex AI model(s) stored on cloud server 150, which model selector 125 accesses via cloud interface 130, described above. Model selector selects a model to respond to the client request, and transmits the client request to it. Model selector then receives the response, and forwards it over communication link 114 to client interface 115, which, in turn, provides the response to client 105, thus closing out the client request.

In one or more embodiments, cache decision maker analyzes an input on a per request basis and decides whether it is better to use the simpler model at the edge, or to use the complex model.

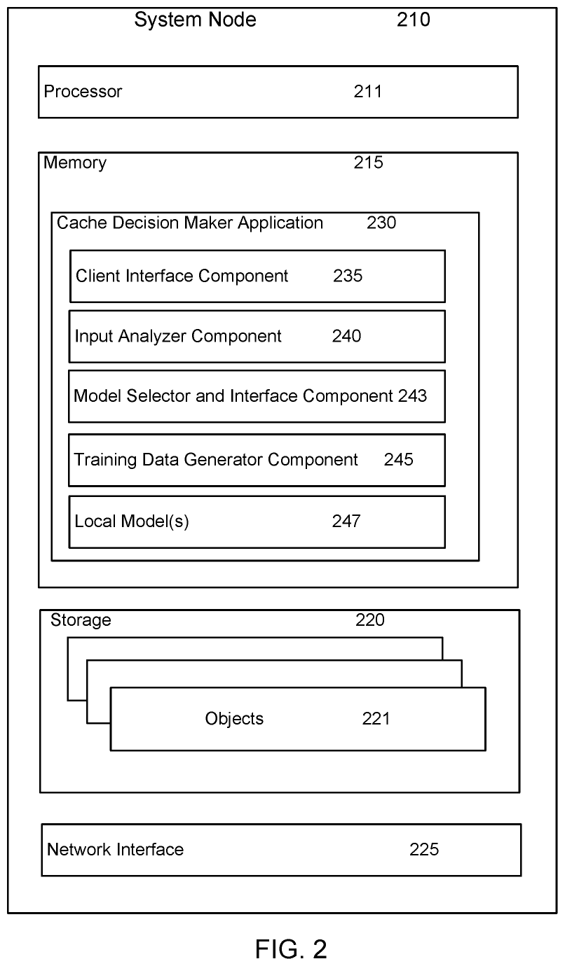

FIG. 2 is a block diagram illustrating a System Node 210 configured to provide selection of an appropriate AI model from two or more available models, according to one embodiment disclosed herein. System Node 210 is equivalent to the edge device 100 schematically depicted in FIG. 1, but, for ease of illustration, without showing in FIG. 2 all of the AI or the various internal (or external) communications pathways that are shown in FIG. 1. In the illustrated embodiment, the system node 210 includes a processor 211, memory 215, storage 220, and a network interface 225. In the illustrated embodiment, the processor 210 retrieves and executes programming instructions stored in memory 215, as well as stores and retrieves application data residing in storage 220. The processor 211 is generally representative of a single CPU, multiple CPUs, a single CPU having multiple processing cores, and the like. The memory 215 is generally included to be representative of a random access memory. Storage 220 may be disk drives or flash-based storage devices, and may include fixed and/or removable storage devices, such as fixed disk drives, removable memory cards, or optical storage, network attached storage (NAS), or storage area network (SAN). Storage 220 may include one or more data bases, including IASPs. Via the network interface 225, the system Node 210 can be communicatively coupled with one or more other devices and components, such as other System Nodes 210, monitoring nodes, storage nodes, and the like.

In the illustrated embodiment, storage 220 includes a set of objects 221. Although depicted as residing in Storage 220, in embodiments, the objects 221 may reside in any suitable location. In embodiments, the Objects 221 are generally representative of any data (e.g., application data, saved files, databases, and the like) that is maintained and/or operated on by the system node 210. Objects 221 may include one or more artificial neural networks (ANNs), one or more convolutional neural networks (CNNs), or the like, which are trained to, and then used to, make inference decisions in response to client requests. Objects 221 may also include a classifier model, such as, for example, classifier model 121 of FIG. 1, to determine whether to use a local version of the AI model, or a counterpart, more complex, version in the cloud. Objects 221 may still further include a set of training data used to train the classifier model, such as, for example, may be generated by a training data generator component 245 of cache decision maker application 230, as described more fully below. As illustrated, the memory 215 includes a cache decision maker application 230. Although depicted as software in memory 215, in embodiments, the functionality of the cache decision maker application 230 can be implemented in any location using hardware, software, firmware, or a combination of hardware, software and firmware. Although not illustrated, the memory 215 may include any number of other applications used to create and modify the objects 221 and perform system tasks on the System Node 210.

As illustrated, the cache decision maker application 230 includes a client interface component 235, an input analyzer component 240, a model selector and interface component 243, a training data generation component 245, and local model(s) 247. Although depicted as discrete components for conceptual clarity, in embodiments, the operations and functionality of the client interface component 235, the input analyzer component 240, the model selector and interface component 243, the training data generation component 245, and local model(s) 247, if implemented in the system node 210, may be combined, wholly or partially, or distributed across any number of components. In an embodiment, the cache decision maker application 230 is generally used to analyze an input on a per request basis and decide whether it is better to use a simpler model at the system node 210, or to use a complex model stored in the cloud. In an embodiment, the cache decision maker application 230 is also used to train, via the training data generator component 245, the classifier model described above, to make the decision as to which model to use, locally stored or cloud version.

In an embodiment, the client interface component 235 is used to provide user interfaces to communicate with client devices, so as to receive client requests and provide responses to those client requests form a selected AI model. In some embodiments, the client interface component 235 is an application programming interface (API) that is automatically accessed by a client application to submit requests, e.g., images of potatoes on a conveyor belt from a potato greening inspection application, or images acquired by a UAV of a bridge surface from a department of highways inspection application, and, in return, receive the results of a model's inference operation.

In the illustrated embodiment, the input analyzer component 240 receives information from the client interface component 235 (e.g., input from a client), and decides, based on that client input, whether to use a locally cached model, such as, for example, local model 247, to execute the client requested inference operation, or whether to use a cloud based more complex version of local model 247. In embodiments, the input analyzer component 240 accesses a stored third AI model, such as, for example model classifier 121 of FIG. 1, to make this decision. Once the appropriate model is chosen, this decision is passed to model selector and interface component 243, which accesses the chosen model, forwards the client request to it, and receives the model's response. The model selector and interface component 243 then provides the model's response to client interface component 235 for forwarding to the client. In an embodiment, the third AI model used by the input analyzer component 240 to make its decision may be trained by training data generated by training data generator component 245.

In embodiments, System Node 210 may communicate with both clients and cloud servers, in which cloud based complex versions of the AI models are stored, via Network Interface 225.

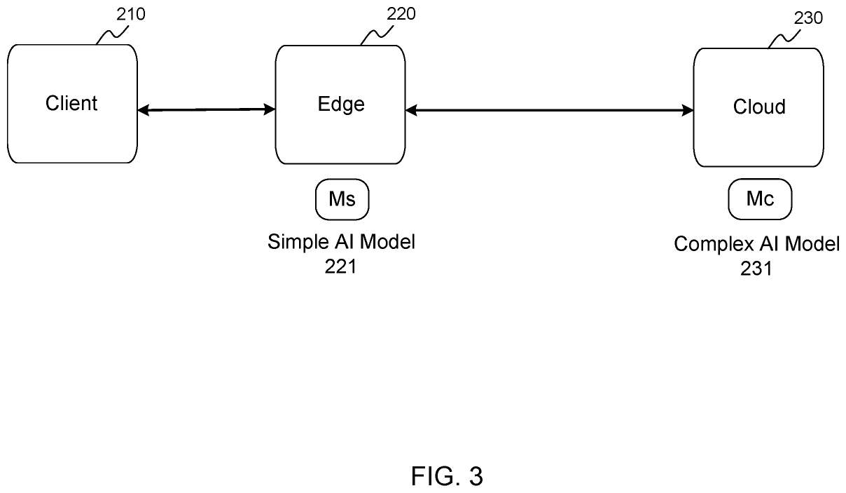

To better illustrate the context of embodiments of the present disclosure, FIG. 3 depicts a conventional example edge device that has a locally saved simple AI model, and that is connected to a complex AI model stored in the cloud. With reference to FIG. 3, there is shown edge device 220 that is connected to a client 210 and to two AI models. A first simple AI model 221 that is locally cached at edge device 220, and a remote, cloud based complex AI model 231, stored on a cloud server 230, as shown. The edge device 220 can execute an inference operation using the simpler AI model 221, but its result may deviate from that of the complex AI model 231. What is desired is that the locally cached model 221 provide the same answer as the complex AI model 231 on the cloud server. However, in the scenario of FIG. 3, it is difficult to determine if the response from the cached model would match that from the cloud service, unless the cloud service is also queried. This process wastes time and computing effort, inasmuch as if the cloud service must always be queried in response to every client submitted request, there is no benefit to also querying the cached model, and no real use to the cached model.

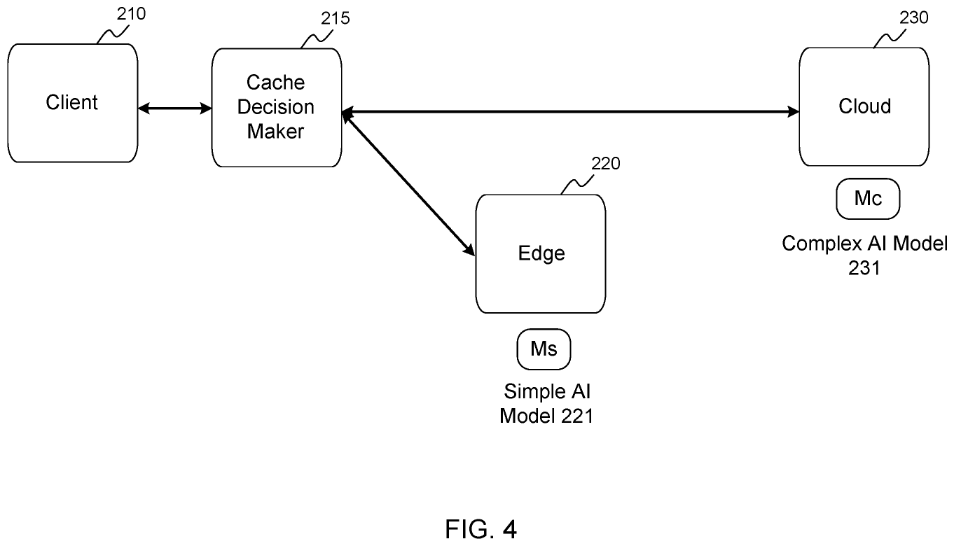

FIG. 4 illustrates a first example system for inference at an edge device, according to one embodiment disclosed herein. The example system of FIG. 4 has all of the elements of the example conventional system of FIG. 3, with the further addition of a cache decision maker 215. Cache decision maker 215 decides on a per request basis whether it is better to use the simpler model at the edge, or to use the complex model. Thus, cache decision maker 215 acts as a gateway between client 210 and the two available AI models, simple AI model 221 and complex AI model 231. In one example, the simple AI model may be a two-tier neural network, and the complex model may be a five stage convolutional neural network. The cache decision maker 215 itself includes a fast AI model that is trained to determine whether the simple AI model 221 would provide results compatible with the complex AI model 231.

In one embodiment, the training data that is used to train the complex model and the simple model is also used to train the decision maker. In one embodiment, the result of running the data through both of the models is compared, and used to create the input to train the decision maker. For example, an input of 1 is used whenever the simple model and the complex model have the same results, and an input of 0 is used whenever they diverge. Alternatively, for example, an input of 1 may be used when the simple model matches either the complex model, or the true label of the input (known a priori at the training data level). Thus, in embodiments, there are two options as to how to train the simple model. In one embodiment, the simple model is trained on the data from the predicted value of the complex model, and in the other embodiment, the simple model is trained on the data containing the true label of the input, as noted above.

It is noted, however, that in many caches, such as, for example, when run in a cache mode, or when run using a complex model provided by a third party, the true input label training data are not available. Thus, in such cases, only the prediction of the complex model is used. In other cases the training data may be available, such as, for example, when used as a front-end proxy load-balancer, and in these cases the true label training data may be used. However, even if the true label training data is available, if the goal is to maximize conformity with the complex model (and thus be able to use the cached model as a replacement of the complex model to respond to a client request), the output from the complex model may be used to train the decision maker instead of the original true label data.

In embodiments, cache decision maker 215 is trained to recognize the types of inputs (e.g., user requests) for which the simple AI model 221 is a good match with the complex model 231, and those inputs for which it is not. In order to train cache decision maker 215 to make this recognition, it uses a training data set of 0 and 1 based on inputs where the results of both the models match or do not match. In embodiments, the cache decision maker 215 is itself a binary classifier determining whether or not the predicted value will be 0 or 1.

As a specific example, the case of two AI models which are used to examine images to check if a manufactured product is defective or good may be considered. In this example the complex AI model 231 may be a complex convolutional neural network (CNN) which performs well for a range of input images. Additionally, the simple AI model 221 may be a decision tree that only performs well if the images are aligned in a specific position (for example, if the product is positioned parallel to a horizontal axis of the image), but when this is the case, provides a result much faster than the complex CNN. On the same training data set the results of the two models are compared, and the cache decision maker 215 is itself trained as a decision tree that can identify whether or not the simpler model will work well for a given set of input images. In one embodiment, this training of cache decision maker 215 can be done on the binary values of the original training data to determine whether or not the two models will match. In an alternate embodiment, to train the cache decision maker, a check may be used that identifies whether product edges in the image are parallel to a horizontal axis.

Thus, in embodiments, the cache decision maker 215 checks incoming requests and decides whether to use the simple AI model 215 at the edge device 220 (known as a “cache hit”), or the more complex AI model 221 in the cloud 230 (known as a “cache miss”). In alternate embodiments, a decision maker need not be specifically provided at an edge device. Rather, the same solution can be used where both the simple AI model 221 and the complex AI model 231 are in the same location, such as, for example, in an AI enabled load-balancer.

As a specific example of AI-enabled load balancer, a front-end proxy for an AI service such as a speech to text converter is considered. The complex speech to text converter is trained to recognize sound samples corresponding to many different accents, and is thus able to convert a multiplicity of accents into a stream of text. However, recognition of multiple accents requires a deep neural network, where the time taken for conversion may be many times more than that of simpler models that recognize only one type of accent. Moreover, it is further assumed in this example that several efficient models, each of which is able to perform speech to text conversion for a single type of accent, e.g., MidWestern Accent, Texan Accent, British accent, and Scottish accent, are available at the same cloud site. In such an example, cache decision maker 215 is trained to determine which accent is used in a specific speech sample, and depending on the specific accent used, it can direct a speech to text conversion request to one of the specialized, accent-specific simple models, or to the more complex speech to text converter if the cache decision maker is unable to determine the proper accent used in the speech sample.

In such load balancing embodiments, the training approaches described above may be used to train the cache decision maker to determine which type of inputs can be proficiently handled by each of the specialized models. Or, for example, alternatively, the decision maker may decide that requests originating from a location in France, as determined by an originating Internet address of the request, are sent to the French accent model, the requests originating from Germany to the German accent model, and the other requests are sent to the complex model. Thus, in embodiments, in a load balancing context, the cache decision maker 215 relegates to one of the more simple AI models any task that they can handle, and only sends “complex” queries to the complex model.

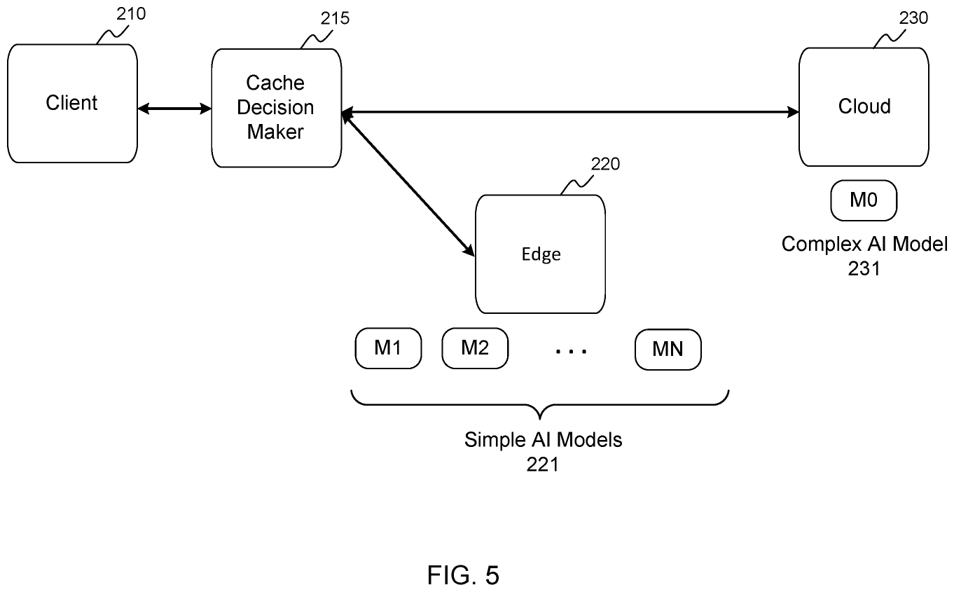

FIG. 5 illustrates a second example system for inference at an edge device, according to one embodiment disclosed herein. The embodiment illustrated in FIG. 5 is identical to the example illustrated in FIG. 4, with the additional element that edge device 220 has not only one cached simple AI model, but rather a full set of simple AI models 221. The set 221 thus includes, as shown, models M1 through MN. In this embodiment, cache decision maker 215 is adapted to choose among the multiple cached models, based upon their respective fidelity with the complex cloud based model 231 and relative performance. It is noted that in the example of FIG. 5, all of models 221 may provide the same type of inference, but could be different. For example, a first model may be based on a CNN, a second model may first use principal component analysis to reduce input images to a set of feature vectors and then use a decision tree, a third model may use a recurrent neural network, a fourth model may be trained to process images that are taken in bright sunlight, and a fifth model may be trained for images that are taken under shady conditions. In the case of the latter two examples, cache decision maker 215 may determine whether an input image was taken under either bright or shady conditions by analyzing the values of the image pixels, for example.

Continuing with reference to FIG. 5, in one embodiment there may be a complex, authoritative model M0 231, provided in a cloud server 230, and several faster models 221, M_1 through M_N, provided at edge device 220. In embodiments, a classifier model provided in cache decision maker 215 may be trained to classify each input instance into an N-dimensional vector where, in each dimension of the vector, a 1 indicates that the faster locally cached model predicted the correct result, or matched the complex model, and 0 otherwise. In embodiments, the classifier model is then used to predict the weights for this vector for new inputs. A combination of the weights and the latency gains from the faster models can be used by cache decision maker 215 to determine which of the many models to apply. For example, it may be assumed that each of the N models 221 has an average inference time of T0, T1 . . . TN, respectively, whereas the complex model 231 has an inference time of TMAX. It may further be assumed that the fidelity of the N models with the complex model is A0, A1, . . . AN, respectively, where A0 through AN are numbers between 0 and 1, where a 1 indicates that the simple model matches the complex model all the time, a 0.5 indicates that the simple model matches the complex model half of the time, etc. In one embodiment the cache decision maker 215 selects the simple model Mi with the highest product of time gain (Ti/TMAX) and fidelity with the complex model 231 (Ai), or, mathematically, the simple model where Ai*Ti/TMAX is maximized.

In one embodiment, the fidelity values of A1, A2, . . . , AN, and average inference time value s T0, T1, . . . TN, may be recomputed periodically. For example, in one embodiment, the cache decision maker 215 may choose to take a small percentage of requests (e.g., 1%) and pass them through all of the models, and over a chosen time period use the resulting data to re-compute the Ai and Ti values, and, if appropriate change its model selections.

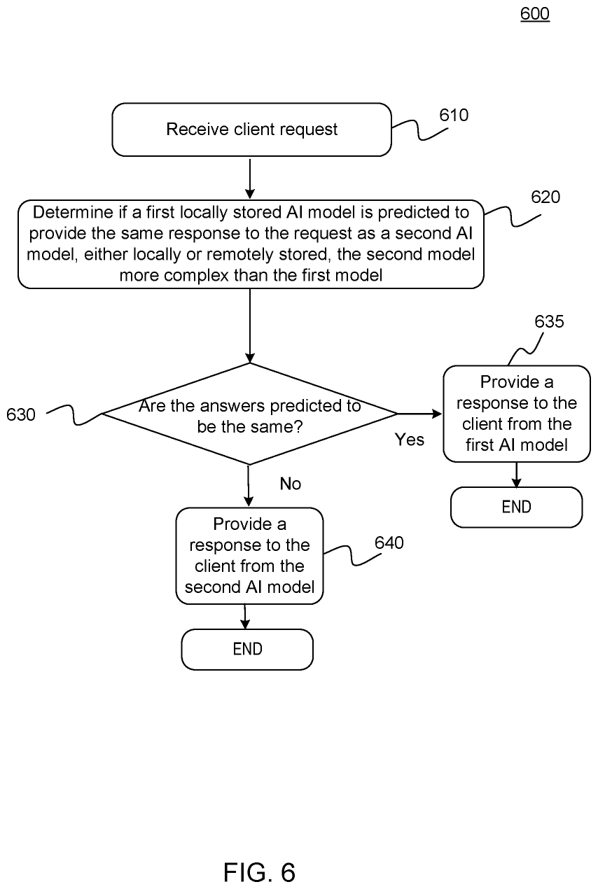

FIG. 6 is a process flow diagram illustrating a method 600 to select an appropriate AI model to respond to a client request, according to one embodiment disclosed herein. Method 600 includes blocks 610 through 650. In alternate embodiments, method 600 may have more, or fewer, blocks. In one embodiment, method 600 may be performed, for example, by edge device 100 of FIG. 1, in particular cache decision maker 110, or, for example, by system node 210 of FIG. 2, and in particular, cache decision maker application 230.

Continuing with reference to FIG. 6, method 600 begins at block 610, where a client request is received. For example, the request may come from an agricultural, manufacturing, or infrastructure inspection application or device, and be received at an edge device on which a simple AI model is cached. Or, for example, the request may be at an AI load balancer. The request may include one or more images of, for example, potatoes or apples, a part of an automobile or other machine, or a bridge, for example, and a request to detect any defects.

From block 610 method 600 proceeds to block 620, where it is determined if a response to the request from a first locally stored AI model is predicted to be the same as a response to the same request from a second AI model, the second AI model either remotely stored in the cloud, or also locally stored, the second AI model more complex than the first AI model. For example, the complex model may have a significantly higher accuracy rate in detecting defects from images in the subject domain of the client request, but, being more complex, may have a much higher latency, as it takes much longer to perform its image analysis and defect recognition. In some examples, the complex AI model may be from 40 to 100 times slower than the simple AI model, and thus the inference latency of the simple models is from 0.025 to 0.01 that of the complex AI model.

From block 620, method 600 proceeds to query block 630, where it is determined whether the determination made in block 620 is affirmative or negative. If the return to query block 630 is a “Yes”, and thus the answers from each of the simple and complex AI models are predicted to be the same, then method 600 proceeds to block 635, where a response is provided to the client request from the first AI model, and method 600 ends.

If, however, a “No” is returned at query block 630, and the simple model is not predicted to provide the same answer as the complex AI model, then method 600 moves to block 640, where a response to the client request is provided from the second AI model, and method 600 then ends.

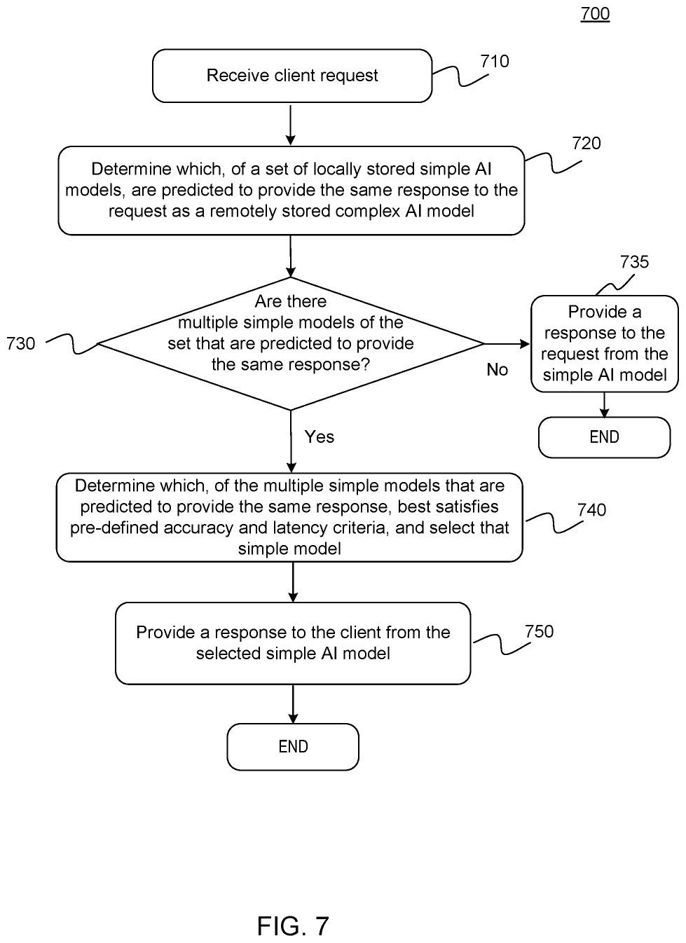

FIG. 7 depicts a process flow diagram of an alternate example AI model selection method, according to one embodiment disclosed herein. FIG. 7 thus illustrates a method 700 to select one out of several possible simple AI models to respond to a client request, according to one embodiment disclosed herein. Method 700 includes blocks 710 through 750. In alternate embodiments, method 700 may have more, or fewer, blocks. In one embodiment, method 700 may be performed, for example, by cache decision maker 110 of FIG. 1, or, for example, by system node 210 of FIG. 2.

Continuing with reference to FIG. 7, method 700 begins at block 710, where a client request is received. For example, the request may come from an agricultural, manufacturing, or infrastructure inspection application or device, and be received at an edge device on which a simple AI model is cached. Or, for example, the request may be at an AI load balancer. The request may include one or more images of, for example, potatoes or apples, a part of an automobile or other machine, or a bridge, for example, and a request to detect any defects.

From block 710 method 700 proceeds to block 720, where it is determined which, of a set of locally stored simple AI models are predicted to provide the same response to the request as a remotely stored complex AI model. For example, the complex model may have a significantly higher accuracy rate in detecting defects from images in the subject domain of the client request, but, being more complex, may have a much higher latency, as it takes much longer to perform its image analysis and defect recognition. For example, the set of locally stored simple AI models have various accuracies in providing a response to the client request, and also have different latencies. This is due, in some embodiments, to some of them being more complex than others, however all of them being simple in relation to the cloud based complex model.

From block 720, method 700 proceeds to query block 730, where it is determined if there are multiple simple models of the set that are predicted to provide the same response as the complex model. If a “No” is returned at query block 730, and there is only one candidate in the set of simple models, then method 700 moves to block 735, where a response to the client request is provided from the single simple AI model that qualifies, and method 700 then ends.

If, however, the return to query block 730 is a “Yes”, and thus the responses from multiple ones of the set of simple AI models are predicted to be the same as what the complex AI model would provide, then method 700 proceeds to block 740, where a determination is made as to which of the multiple simple AI models to choose to respond to the client request. In embodiments, this is a function of how well the set of simple models satisfies pre-defined accuracy and latency criteria. For example, as noted above, in one embodiment the simple model is chosen that maximizes the mathematical relationship Ai*Ti/TMAX, where, for the set of simple models Mi, Ai is an index of fidelity with the remotely stored complex AI model, where A is a number between 0 and 1, Ti is the average inference time of the simple AI model. Further, TMAX is the inference time of the complex AI model. Thus, Ti/TMAX measures the fractional latency relative to the complex AI model, and Ai measures accuracy in terms of predicted fraction of times the simple model Mi has the same result as the complex AI model. In other embodiments, different variables and/or metrics may be used for the determination at block 740.

Once a simple model is selected at block 740, method 700 proceeds to block 750, where a response is provided to the client from the selected simple AI model, and method 700 ends.

It is noted, to illustrate operation of one embodiment according to the present disclosure, that simulations were run using a simpler model (a two-tier neural network) and a complex model (a five stage convolutional neural network) on two common image recognition data sets, namely the Fashion Modified National Institute of Standards and Technology (MINST) data set, and the MINST data set. These databases are commonly used, for example, to train image processing as well as machine learning systems. The following results were obtained to the simulations, which included a single simple AI model cached at an edge device, and a single complex AI model provided on a cloud server, accessed by the edge device over a data communications network.

On the Fashion MNIST data set, the simpler AI model had an accuracy rate of 78% while the complex AI model had an accuracy rate of 88%. A decision maker provided at the edge device resulted in a decision to use the simple AI model only 27% of the time, resulting in a net accuracy of 85%. In this experiment, the inference time for the complex AI model was 67 times that of the simpler model, with the resulting system having an inference time of 49 times the simpler model, a substantial gain in accuracy with a speed-up of 26% compared to the complex model.

On the MNIST data set, the simpler AI model had an accuracy rate of 78% while the complex AI model had a 98% accuracy, but was 51 times slower. Using the approach described above, the resulting accuracy rate was 78% with the cached simple AI model being used 85% of the times. These simulation results show that, in embodiments, a combined model approach, where a decision maker selects, on a per request basis, among multiple models, may achieve an optimal trade-off between simple and complex AI models.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference has been made to various embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the above described aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications that generate medical records from either an audio recording of a doctor-patient dialogue or a written record of such a doctor-patient dialogue or related data available in the cloud. Each health care professional interacting with a given patient could, for example, record all patient interactions, or, for example, first visit interactions for a new condition or sickness, and upload the recordings to the cloud. Or, for example, the recordings may be automatically uploaded periodically by a cloud service. For example, the medical record generation application could execute on a computing system in the cloud and store all medical records that have been generated by it at a storage location in the cloud. The medical record generation application could produce the medical records in a pre-defined format, such as hard or soft format, as described above, or, for example, it could produce them in both formats, and they may be accessed by different users according to the user's preferred format. For example, different insurance companies may desire different formats of medical records to be used in their underwriting, auditing, or claim payment functions. Doing so allows a user to access this information from any computing system attached to a network connected to the cloud (e.g., the Internet), and thus facilitates a central depository of all of a patient's medical records.

While the foregoing is directed to embodiments of the present invention, other and further embodiments of the invention may be devised without departing from the basic scope thereof, and the scope thereof is determined by the claims that follow.

What is claimed is:

1. A method comprising:
receiving a request from a client;
determining if a first response to the request from a first locally stored artificial intelligence (AI) model is predicted to be the same as a second response to the request from a second either locally or remotely stored AI model, the second AI model more complex than the first;
in response to a determination that the first and second responses are predicted to be the same, selecting the first model; and
providing a response to the client from the first model.

2. The method of claim 1, further comprising:
in response to a determination that the first and second responses are not predicted to be the same, selecting the second model;
obtaining a response from the second model; and
providing to the client the response from the second model.

3. The method of claim 1, wherein the first model is a simplified version of the second model.

4. The method of claim 3, wherein the first model is generated from the second model using at least one of transfer learning or model compression.

5. The method of claim 1, wherein the second model is remotely stored and accessible over a computer communications network.

6. The method of claim 1, wherein the second model is also locally stored, and wherein the device is an AI-enabled load balancer.

7. The method of claim 1, wherein at least one of:
the first model has a faster response time than the second model; or
the second model has a greater accuracy than the first model.

8. The method of claim 1, wherein the determining further includes using a third AI model that is trained to predict when the responses of the first model and of the second model will match.

9. The method of claim 8, wherein the third AI model is trained by:
obtaining a training data set comprising client requests;
inputting the training data set into each of the first model and the second model;
identifying, for each input of the training data, whether the results from each model match or do not match; and
using the client requests and their respective matching results, training the third AI model to recognize the types of client requests where the first model is suitable for response, and those types of client requests for which it is not.

10. The method of claim 8, wherein the third AI model is a binary classifier.

11. A system, comprising:
a client interface configured to receive a client request and provide a response;
a memory, configured to store a first AI model;
a network interface, configured to communicate with a second AI model stored on a cloud server, the second AI model more complex than the first;
a cache decision maker, coupled to the client interface, configured to
analyze the client request; and
based at least in part on the analysis, select either the first AI model or the second AI model to respond to the request.

12. The system of claim 11, wherein the memory is further configured to store a set of first AI models, and the cache decision maker is further configured to select either one of the set of first AI models or the second AI model, based at least in part on the analysis.

13. The system of claim 11, further comprising:
a training data generator configured to:
compare the output of at least the first AI model with the output of the second AI model;
determine the conditions under which their outputs match; and
output training data.

14. The system of claim 13, wherein the cache decision maker further comprises a model classifier trained on the output of the training data generator to identify a most suitable model.

15. The system of claim 11, wherein the first model is generated from the second model using at least one of transfer learning or model compression.

16. A computer program product for model selection at an edge device, the computer program product comprising:
a computer-readable storage medium having computer-readable program code embodied therewith, the computer-readable program code executable by one or more computer processors to:
receive a request from a client;
determine if a first response to the request from a first locally stored AI model is predicted to be the same as a second response to the request from a second either locally or remotely stored AI model, the second AI model more complex than the first;
in response to a determination that the responses are predicted to be the same, select the first model; and
provide a response to the client from the first model.

17. The computer program product of claim 16, wherein the computer-readable program code is further executable to:
determine if the first and second responses are predicted to be the same by accessing a third AI model that is trained to determine the conditions under which the results of the first model and the results of the second model will match.

18. The computer program product of claim 17, wherein the third AI model is a binary classifier.

19. The computer program product of claim 16, wherein the first model is generated from the second model using at least one of transfer learning or model compression.

20. The computer program product of claim 16, wherein the wherein the second model is also locally stored, and wherein the device is an AI-enabled load balancer.
